(19) United States
(12) Patent Application Publication
(10) Pub. No.: US 2022/0399636 A1
(43) Pub. Date: Dec. 15, 2022

(54) CONNECTING ELEMENT, CONNECTION DEVICE, RADOME SUPPORTING MEMBER AND BASE STATION ANTENNA

(71) Applicant: CommScope Technologies LLC, Hickory, NC (US)

(72) Inventor: Bin Ai, Suzhou (CN)

(21) Appl. No.: 17/828,766

(22) Filed: May 31, 2022

(30) Foreign Application Priority Data
Jun. 10, 2021 (CN) 202110645274.6

(51) Int. Cl. H01Q 1/24; H01Q 1/20; H01Q 1/42

(52) U.S. Cl. CPC H01Q 1/246; H01Q 1/20; H01Q 1/42

(57) ABSTRACT

A connecting element has a body and a plug-in component. The body has a base surface, an end side extending laterally relative to the base surface, and a cavity open toward the end side, and a slot opening toward the end side is provided in a wall of the cavity facing the base surface. The plug-in component protrudes from the base surface, is spaced apart from the end side, and has a stalk portion and a head portion. A matching pair of connecting elements can be connected to each other so that one connecting element is inserted into the cavity of the other connecting element with its. head portion inserted from the end side of the other connecting element; during insertion, the one connecting element is guided with its stalk portion in the slot of the other connecting element, and the base surfaces of the pair of connecting elements oppose and are spaced apart from each other in a connected state.

### RELATED APPLICATION

The present application claims priority from and the benefit of Chinese Patent Application No. 202110645274.6, filed Jun. 10, 2021, the disclosure of which is hereby incorporated herein by reference in full.

### FIELD OF THE INVENTION

The present disclosure relates to the technical field of connection, and more specifically, to a connecting element, and a connection device, a radome supporting member, and a base station antenna including the connecting element.

### BACKGROUND OF THE INVENTION

A generally known base station antenna may include a radome and an antenna assembly received in the radome, and the antenna assembly may include a reflecting plate and a radiator protruding from the reflecting plate. Certain known base station antennas may have a plurality of reflecting plates, for example, two, three or more reflecting plates. Each reflecting plate may have two longitudinal rim areas, and two adjacent longitudinal rim areas of two reflecting plates may be spaced apart from each other. The antenna assembly may be provided with a radome supporting member so that the radome can be supported relative to the antenna assembly by the radome supporting member, or the antenna assembly can be supported in the radome by the radome supporting member.

In practice, the radome may have different shapes and sizes, and the reflecting plate may also have different shapes and sizes. Typically, reflecting plates of different sizes require different specially designed radome supporting members, and this may mean higher costs. Versatility of the radome supporting member is expected. In addition, easy installation of the radome supporting member is also desirable.

### SUMMARY OF THE INVENTION

An object of the present disclosure is to provide a connecting element, and a connection device, a radome supporting member, and a base station antenna including such a connecting element.

A first aspect of the present disclosure relates to a connecting element, including:

a body, which has a base surface, an end side extending laterally relative to the base surface, and a cavity open toward the end side, a slot opening toward the end side being provided in a wall of the cavity facing the base surface; and

a plug-in component, which protrudes from the base surface, is spaced apart from the end side, and has a stalk portion and a head portion;

wherein the connecting element is configured such that a matching pair of connecting elements can be connected to each other in the following way: one connecting element is inserted into the cavity of the other connecting element with its head portion inserted from the end side of the other connecting element; during insertion, the one connecting element is guided with its stalk portion in the slot of the other connecting element, and the base surfaces of the pair of connecting elements are opposing each other and are spaced apart from each other in a connected state.

A pair of connecting elements according to the present disclosure can be easily installed and a reliable connection can be established. The connecting element can be widely used, especially in a base station antenna. The connecting element may be a separate connecting element, or may be integrated into a functional member as an integral part of the functional member.

In some embodiments, the connecting element may have a spacer protruding laterally from the stalk portion of the plug-in component. The spacer divides the stalk portion into two sections, and the spacer is configured to space a first member received on a first side of the spacer facing the base surface apart from a second member received on a second side of the spacer facing away from the base surface.

In a pair of connecting elements according to the present disclosure, it is possible that only one of the connecting elements has the spacer while the other connecting element does not have such a spacer. Alternatively, each connecting element may have the spacer, and these spacers may be aligned with each other in a state in which the pair of connecting elements are connected.

In some embodiments, the stalk portion and the head portion may be respectively formed as a plate-shaped component. For example, the stalk portion and a section of the head portion close to the stalk portion may together have a T-shaped cross section.

In some embodiments, the connecting element may have two spacers protruding laterally from two side surfaces of the stalk portion. For example, the two spacers and the stalk portion may together have a cross-shaped cross section.

In some embodiments, the connecting element may have a positioning component, which is configured to fix the connecting element in a movement direction of the connecting element defined by the base surface and the stalk portion.

In some embodiments, the positioning component may be formed as a buckle element.

In some embodiments, the positioning component may be formed as a protrusion protruding from the base surface, for example, two protrusions side by side.

In some embodiments, the connecting element may be formed integrally. For example, the connecting element may be integrally formed of a plastic material by injection molding.

In some embodiments, the connecting element may be configured to be used for a base station antenna, and in particular may be configured as a radome supporting member for a base station antenna.

A second aspect of the present disclosure relates to a connection device, which includes a pair of the connecting elements according to the first aspect of the present disclosure, the pair of connecting elements being capable of being connected to each other in the following way: one connecting element is inserted into a cavity of the other connecting element with its head portion inserted from an end side of the other connecting element; during insertion, the one connecting element is guided with its stalk portion in a slot portion of the other connecting element, and base surfaces of the pair of connecting elements are opposing each other and are spaced apart from each other in a connected state.

In some embodiments, only one of the connecting elements may have a spacer while the other connecting element does not have a spacer. Alternatively, each connecting element may have a spacer, and in particular, the spacers may be aligned with each other in a state in which the pair of connecting elements are connected.

In some embodiments, the pair of connecting elements may be configured the same.

In some embodiments, the pair of connecting elements may be configured differently.

In some embodiments, the one connecting element may have a positioning component formed as a buckle element and the other connecting element may have a positioning component formed as a protrusion protruding from its base surface.

A third aspect of the present disclosure relates to a radome supporting member for a base station antenna, where the radome supporting member extends in an elongated shape and has at least one connecting element according to the first aspect of the present disclosure.

In some embodiments, the radome supporting member may extend substantially in an arc shape.

In some embodiments, the radome supporting member may have, and in particular be integrated with, the connecting elements respectively on two ends of the radome supporting member.

In some embodiments, the connecting element may be fixed to the radome supporting member as a separate member. Alternatively, the connecting element may be integrated on the radome supporting member.

In some embodiments, the radome supporting member may have a connection part for installing accessories in its extension.

In some embodiments, the radome supporting member, especially the radome supporting member and the connecting element, may be integrally formed of a plastic material by injection molding.

A fourth aspect of the present disclosure relates to a base station antenna, which includes a plurality of reflecting plates, the reflecting plates having longitudinal rim areas, two longitudinal rim areas of at least two reflecting plates being adjacent to each other and spaced apart from each other, wherein the connecting element according to the first aspect of the present disclosure, or the connection device according to the second aspect of the present disclosure, or the radome supporting member according to the third aspect of the present disclosure is mounted on the two longitudinal rim areas.

In some embodiments, the base station antenna or an antenna assembly of the base station antenna may include two or three or more reflecting plates, where each reflecting plate has two longitudinal rim areas, the two longitudinal rim areas of each two reflecting plates are adjacent to each other and spaced apart from each other, and the connecting element or the connection device or the radome supporting member is mounted on the two longitudinal rim areas of each two reflecting plates.

In some embodiments, the base station antenna may include at least one set of radome supporting members, and each set of radome supporting members are connected to one another and connected to the reflecting plates, forming a continuous and closed radome supporting structure on a circumference of the base station antenna.

In some embodiments, the base station antenna may include a single radome supporting member connected to the reflecting plate, the radome supporting member extending over a part of the circumference, for example, about ⅓ of the circumference of the base station antenna, and the radome supporting member being respectively connected to a separate matching connecting element by the connecting elements integrated on the two ends of the radome supporting member.

In some embodiments, the base station antenna may include a plurality of radome supporting members that are connected to each other and connected to the reflecting plates, the plurality of radome supporting members as a whole extending over a part of the circumference of the base station antenna, and the plurality of radome supporting members as a whole being respectively connected to a separate matching connecting element by the connecting elements integrated on the two ends of the radome supporting member. For example, two radome supporting members are connected to each other and extend as a whole over about ⅔ of the circumference, wherein the two radome supporting members are connected to the reflecting plate through three pairs of connecting elements. Two pairs of outer connecting elements are respectively formed by a single connecting element and a connecting element integrated on the radome supporting member, and a pair of central connecting elements are formed by two connecting elements integrated on the radome supporting members.

In some embodiments, the base station antenna may include at least a pair of separate matching connecting elements.

In some embodiments, the radome may have a circular, elliptical, or nearly rectangular cross section.

It should be pointed out here that the above-mentioned technical features, the technical features to be mentioned below and the technical features that can be obtained separately in the drawings can be arbitrarily combined with each other as long as the combined technical features are not contradictory. All technically feasible feature combinations are technical contents included in the Specification.

### BRIEF DESCRIPTION OF THE DRAWINGS

The present disclosure will be explained in more detail by means of embodiments with reference to the attached drawings. Among them,

FIGS. 1A to 1C are exploded views of a pair of connecting elements.

FIGS. 2A to 2C are a plurality of views of the pair of connecting elements of FIGS. 1A to 1C in a connected state, wherein FIG. 2C shows the connecting elements mounted on first and second members.

FIGS. 3A and 3B are partial plane views of a first member and a second member in FIG. 2C.

FIGS. 4A to 4C are a front view, a perspective view, and a partially enlarged perspective view of a radome supporting member according to an embodiment of the present disclosure.

FIGS. 5 to 8 are cross-sectional views of a base station antenna according to a plurality of embodiments of the present disclosure.

FIG. 9 is a partial perspective view of an antenna assembly of the base station antenna of FIG. 5.

FIG. 10 is an enlarged partial view of the antenna assembly shown in FIG. 9.

FIGS. 11 and 12 are partial views depicting an installation process of a pair of connecting elements.

### DETAILED DESCRIPTION OF SPECIFIC EMBODIMENTS

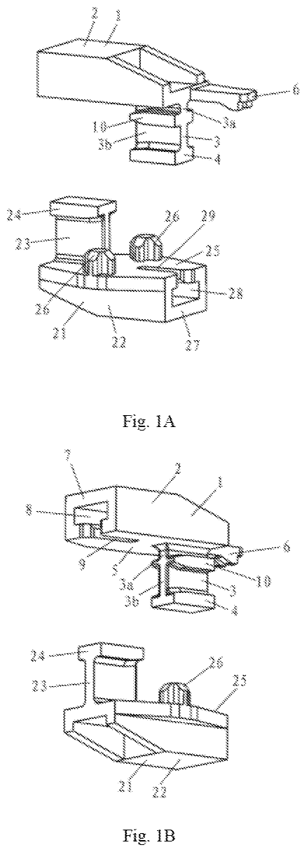

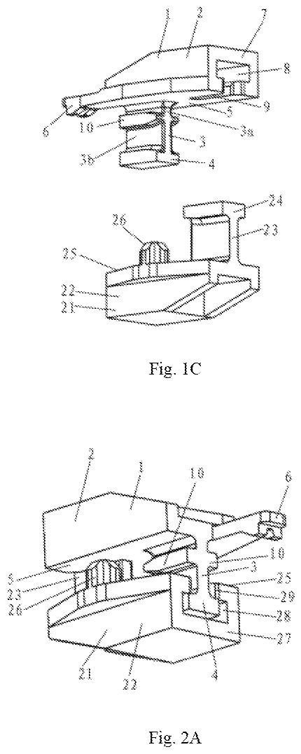

First, two embodiments of a connecting element according to the present disclosure will be described with reference to FIGS. 1A to 1C and FIGS. 2A to 2C. Two matching connecting elements 1 and 21 can form a connection device according to the present disclosure. FIGS. 1A to 1C are exploded views of a pair of connecting elements. FIGS. 2A to 2C are two perspective views and one front view of the pair of connecting elements in a connected state, wherein pails of two plate-shaped members are additionally depicted in FIG. 2C.

Hereinafter, in order to distinguish the two connecting elements 1 and 21, the connecting element 1 may also be referred to as a first connecting element, and the connecting element 21 may also be referred to as a second connecting element. Each connecting element may be made of plasticas a monolithic component, for example, by an injection molding process.

The first connecting element 1 has a body 2, which may have a base surface 5, an end side 7 extending laterally relative to the base surface 5, and a cavity 8 open toward the end side. A slot 9 opening toward the end side 7 is provided in a wall of the cavity 8 facing the base surface 5. As a result, the slot 9 can have a free inlet end that opens into the end side 7 and an opposing closed end, which may be used as a stopping portion.

The first connecting element 1 further has a plug-in component. The plug-in component protrudes from the base surface 5 and is spaced apart from the end side 7. The plug-in component has a stalk portion 3 and a head portion 4, and an optional spacer 10. The plug-in component may be arranged approximately centrally in the width of the first connecting element and extend substantially longitudinally. The stalk portion 3 and the head portion 4 may be respectively formed as a plate-shaped component. Two spacers 10 may protrude laterally from two side surfaces of the stalk portion 3. The spacer 10 divides the stalk portion 3 into two sections 3a and 3b. The stalk portion 3 and a section of the head portion 4 close to the stalk portion 3 may together have a T-shaped cross section. The two spacers 10 and the stalk portion 3 may together have a cross-shaped cross section. The end side of the plug-in component that is far away from the end side 8 and the end side of the body 2 that is opposite to the end side 8 may be aligned with each other to be on a common plane. The first connecting element 1 may further have a positioning component 6, which is formed as a latch element. The positioning component 6 may protrude from the end side of the body 2. that is opposite to the end side 8. The positioning component 6 may be substantially coplanar with the base surface 5.

The second connecting element 21 has a body 22, which may have a base surface 25, an end side 27 extending laterally relative to the base surface 25, and a cavity 28 open toward the end side. A slot 29 opening toward the end side 27 is provided in a wall of the cavity 28 facing the base surface 25. As a result, the slot 29 can have a free inlet end that opens into the end side 27 and an opposing closed end, which may be used as a stopping portion. The second connecting element 21 further has a plug-in component. The plug-in component protrudes from the base surface 25 and is spaced apart from the end side 27. The plug-in component has a stalk portion 23 and a head portion 24 but does not have a spacer which is the same as or similar to the spacer 10 of the first connecting element 1. The plug-in component of the second connecting element 21 may be arranged approximately centrally in the width of the second connecting element 21 and extend substantially longitudinally. The stalk portion 23 and the head portion 24 may be respectively formed as a plate-shaped component. The stalk portion 23 and the head portion 24 may together have a T-shaped cross section. The end side of the plug-in component of the second connecting element 21 that is far away from the end side 28 and the end side of the body 22 that is opposite to the end side 28 may be aligned with each other to be on a common plane. The second connecting element 21 may further have two positioning components 26, which are formed as protrusions protruding from the base surface 25.

In an embodiment not shown, the first connecting element 1 may not have the illustrated spacer 10, and the second connecting element 21 may have the illustrated spacer 10.

In another embodiment not shown, not only the first connecting element 1 but also the second connecting element 21 can each have the illustrated spacer 10, and these spacers may be aligned with each other to be on a common plane in a state in which the two connecting elements 1 and 21 are connected.

As shown in FIGS. 2A to 2C, the first connecting element 1 can be inserted into the cavity 28 of the second connecting element 21 with its head portion 4 inserted from the end side 27 of the second connecting element 21, and at the same time, the second connecting element 21 can be inserted into the cavity 8 of the first connecting element 1 with its head portion 24 inserted from the end side 7 of the first connecting element 1. During the insertion of the two connecting elements 1 and 21 into each other, the first connecting element 1 is guided with its stalk portion 3 in the slot 29 of the second connecting element 21, and at the same time, the second connecting element 21 is guided with its stalk portion 23 in the slot 9 of the first connecting element 1. In a state in which the two connecting elements 1 and 21 are connected, the base surfaces 5 and 25 are opposing each other and are spaced apart from each other. As shown in FIG. 2C, a first member 11 may be located between the base surface 5 of the first connecting element 1 and the spacer 10, and a second member 12 may be located between the spacer 10 and the base surface 25 of the second connecting element 21. The first member 11 and the second member 12 can be kept spaced apart by the spacer 10.

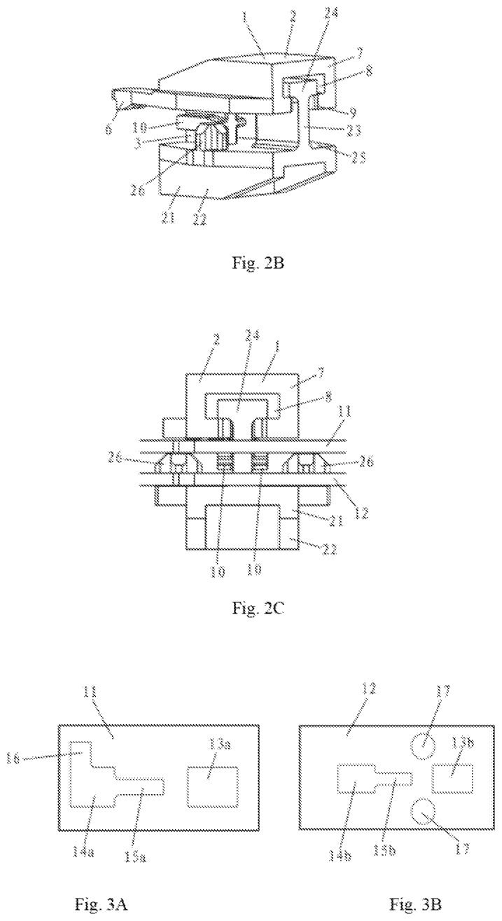

For the installation of the two connecting elements 1 and 21 on the two members 11 and 12, the two members may each have at least one hole area. For example, as shown in FIG. 3A, the first member 11 may have a hole area 14a for the plug-in component of the first connecting element 1 to pass through, a hole area 13a for the plug-in component of the second connecting element 21 to pass through, a hole area 15a for allowing the first connecting element 1 to move with the section 3a of its stalk portion 3 from the hole area 14a towards the hole area 13a, and a hole area 16 for receiving the positioning component 6. The second member 12 may have a hole area 14b for the plug-in component of the first connecting element 1 to pass through, a hole area 13b for the plug-in component of the second connecting element 21 to pass through, a hole area 15b for allowing the first connecting element 1 to move with the section 3b of its stalk portion 3 from the hole area 14b towards the hole area 13b, and a hole area 17 for receiving the two positioning components 26 (see FIG. 3B).

As can be seen from FIG. 2C and FIGS. 3A and 3B, the second connecting element 21 is positioned on the lower side of the second member 12, wherein the plug-in component of the second connecting element 21 passes through the hole area 13b of the second member 12 and the hole area 13a of the first member 11 in this order, and the two positioning components 26 of the second connecting element 21 are inserted into the hole area 17 of the second member 12; the base surface 25 of the second connecting element 21 abuts on the lower side of the second member 12, and the second connecting element 21 is fixed and cannot move along the lower side of the second member 12. The first connecting element 1 is positioned on the upper side of the first member 11, wherein the plug-in component of the first connecting element 1 passes through the hole area 14a of the first member 11 and the hole area 14b of the second member 12 in this order. Then, the first connecting element 1 moves along the upper side of the first member 11, so that the stalk portion of the first connecting element 1 moves from the hole area 14a of the first member 11 and the hole area 14b of the second member 12 to the hole area 15a of the first member 11 and the hole area 15b of the second member 12. The positioning component 6 of the first connecting element 1 formed as a latch element is snapped in the hole area 16. As a result, the first connecting element 1 is fixed and cannot move along the upper side of the first member 11. In addition, the head portion 4 of the first connecting element 1 is hooked in the cavity 28 of the second connecting element 21, and the head portion 24 of the second connecting element 21 is hooked in the cavity 8 of the first connecting element 1. Therefore, the two connecting elements 1 and 21 are connected to each other in a direction perpendicular to the first member 11 and the second member 12 and cannot be separated from each other.

When disassembling the connection device, first the positioning component 6 is released from the hole area 16; then the first connecting element 1 is moved along the upper side of the first member 11, so that the stalk portion of the first connecting element 1 is moved from the hole area 15a of the first member 11 and the hole area 15b of the second member 12 to the hole area 14a of the first member 11 and the hole area 14b of the second member 12; next, the first connecting element 1 can be pulled out from the upper side of the first member 11 and the second connecting element 21 can be pulled out from the lower side of the second member 12.

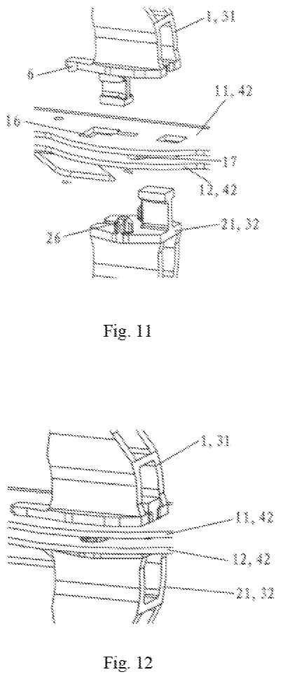

Regarding the installation of two matching connecting elements on two members, further reference may be made to FIGS. 11 and 12. FIG. 11 depicts two matching connecting elements 1 and 21 or 31 and 32 to be mounted on the two members 11 and 12 or two longitudinal rim areas 42, and FIG. 12 depicts a state in which the installation is completed.

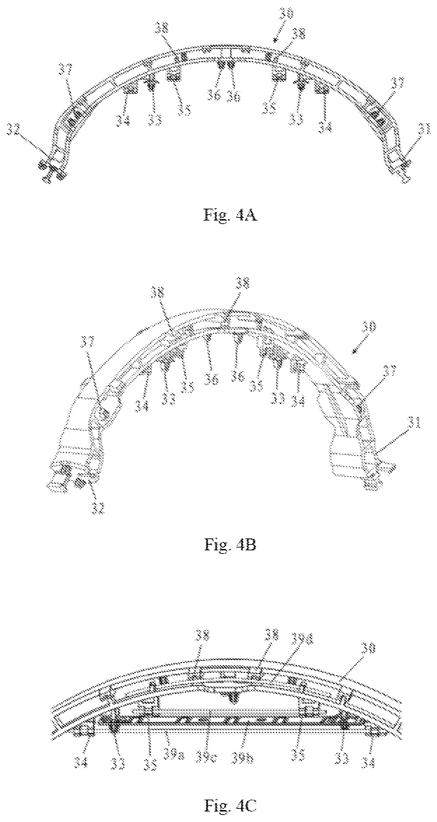

FIGS. 4A to 4C are a front view, a perspective view, and a partially enlarged perspective view of a radome supporting member 30 according to an embodiment of the present disclosure, wherein a plurality of accessories 39a to 39d mounted to the radome supporting member 30 are additionally depicted in FIG. 4C.

The radome supporting member 30 may be made of any suitable material. For example, it may be integrally formed of a plastic material by injection molding. The radome supporting member 30 may extend in an elongated shape, for example, in a substantially arcuate shape. The radome supporting member 30 may have connecting elements on both ends, respectively. In an illustrated embodiment, the connecting element 31 integrated on one end of the radome supporting member 30 may be configured the same as or similar to the aforementioned first connecting element 1, and the connecting element 32 integrated on the other end of the radome supporting member 30 may be configured the same as or similar to the aforementioned second connecting element 21.

In an embodiment not shown, the two connecting elements integrated on the two ends of the radome supporting member 30 may be respectively configured the same as or similar to the first connecting element 1, or may be respectively configured the same as or similar to the second connecting element 21. As an alternative or supplement to the integration of the connecting element on the end of the radome supporting member 30, the connecting element ma also be integrated on other parts of the radome supporting member 30. For example, the radome supporting member may include two outer connecting elements and one central connecting element throughout its extension.

The radome supporting member 30 may have connection parts 33 to 38 for installing the accessories 39a to 39d in its extension. These connection parts may be in the form of latch elements, studs, recesses or the like. The accessories 39a to 39d may be, for example, parasitic elements for adjusting the electrical properties of the base station antenna. These accessories may be rod-shaped elements, planar elements or elements in any other form.

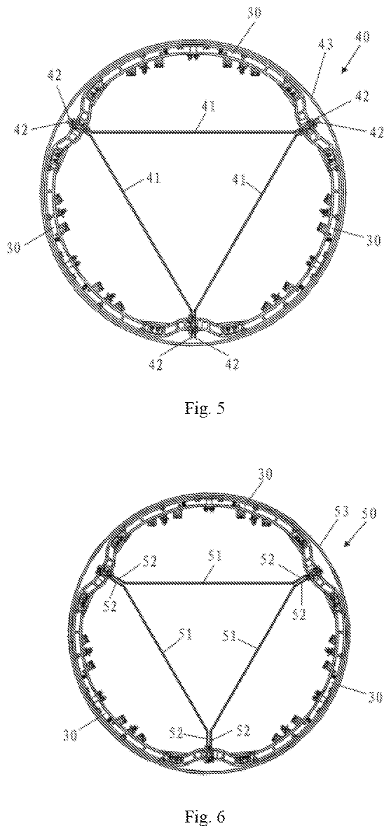

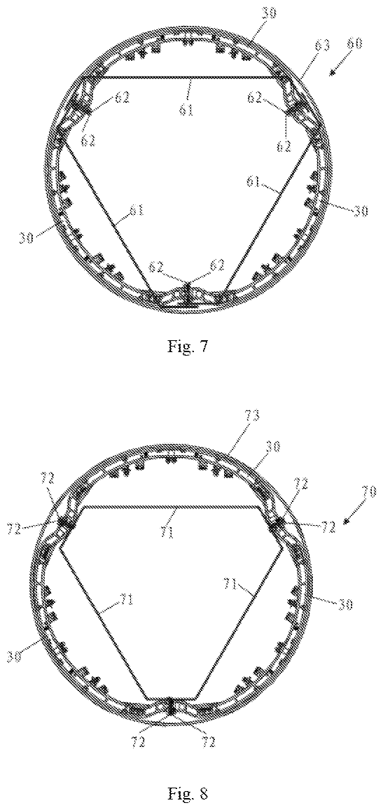

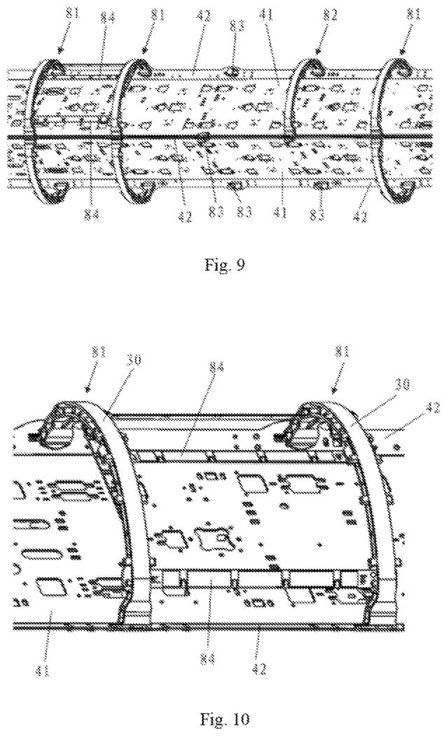

FIG. 5 is a cross-sectional view of a base station antenna 40 according to a first embodiment of the present disclosure. More details of the base station antenna 40 are also shown in FIGS. 9 and 10, where a radome 43 of the base station antenna 40 is hidden in FIG. 9, and an antenna assembly of the base station antenna 40 received in the radome 43 is depicted in partial length; an enlarged partial view of the antenna. assembly of FIG. 9 is shown in FIG. 10.

The base station antenna 40 includes three reflecting plates 41, and each reflecting plate 41 has two longitudinal rim areas 42. In the cross-section of the base station antenna 40, these reflecting plates 41 enclose a substantially triangular shape. In the cross-section shown in FIG. 5, a set of radome supporting members 30 (three radome supporting members 30 in the figure) are connected to one another and connected to the reflecting plates 41, forming a continuous and closed radome supporting structure 81 on a circumference of the base station antenna 40. The two longitudinal rim areas 42 of each two reflecting plates 41 are adjacent to each other and spaced apart from each other, where the two matching connecting elements 31 and 32 of each two radome supporting members 30 on their two adjacent ends are mounted on the two longitudinal rim areas 42. The two connecting elements 31 and 32 may correspond to the aforementioned first connecting element 1 and second connecting element 21 in terms of function and structure, and the two longitudinal rim areas 42 may correspond to the aforementioned first member 11 and second member 12 in terms of function and structure. For brevity, the accessories 39a to 39d that are mounted on the radome supporting member 30 through the connection pails 33 to 38 of the radome supporting member 30 are omitted in FIG. 5.

As can be seen from FIG. 9, the antenna assembly of the base station antenna 40 may include three radome supporting structures 81, each of which includes a set of radome supporting members 30 (three radome supporting members 30 in the figure).

A single radome supporting member 30 can further be seen in FIG. 9. The two integrated connecting elements 31 and 32 of the radome supporting member 30 may be respectively combined with a separate matching connecting element 1, 21, thereby forming a radome supporting structure 82 extending approximately on a ⅓ circular arc. The radome supporting structure has two connection devices. One connection device includes a connecting element 31 integrated on the radome supporting member 30 and a separate connecting element 21, and the other connection device includes a connecting element 32 integrated on the radome supporting member 30 and a separate connecting element 1. Each connection device is mounted on two adjacent longitudinal rim areas 42 of the reflecting plate 41 and spaces the two longitudinal rim areas 42 apart from each other.

A plurality of connection devices 83 can also be seen in FIG. 9, each of which includes a pair of separate matching connecting elements 1 and 21. Each connection device 83 is mounted on two adjacent longitudinal rim areas 42 of two reflecting plates 41 and spaces the two longitudinal rim areas 42 apart from each other by the spacer 10 of the connection device.

As can be seen from FIGS. 9 and 10, at least one accessory 84 may be installed between adjacent radome supporting members 30 through the connection parts on the radome supporting members 30 in the longitudinal direction of the antenna assembly. The accessory may be, for example, a parasitic element for adjusting the electrical properties of the base station antenna, or a cable or the like.

FIG. 6 is a cross-sectional view of a base station antenna 50 according to a second embodiment of the present disclosure. The base station antenna 50 includes a radome 53 and three reflecting plates 51, and each reflecting plate 51 has two longitudinal rim areas 52. In the second embodiment, the radome 53 and the radome supporting member 30 may be configured the same as in the first embodiment. The second embodiment can differ from the first embodiment mainly in that, as viewed in the cross section of the base station antenna 50, comparing with the reflecting plate 41, the width of the middle section of the reflecting plate 51 for installing a radiator is smaller, and the width of the two longitudinal rim areas 52 of the reflecting plate 51 is greater.

FIG. 7 is a cross-sectional view of a. base station antenna 60 according to a third embodiment of the present disclosure. The base station antenna 60 has a radome 63 and three reflecting plates 61, and each reflecting plate 61 has two longitudinal rim areas 62. In the third embodiment, the radome 63 and the radome supporting member 30 may be configured the same as in the first embodiment. The third embodiment can differ from the first embodiment mainly in that, as viewed in the cross section of the base station antenna 60, comparing with the reflecting plate 41, each reflecting plate 61 is farther away from the center of the circular base station antenna, wherein the longitudinal edge area of each reflecting plate 61 is bent and extends radially inward from a radially outer part of a radome supporting structure formed by three radome supporting members 30 through the radome supporting structure.

FIG. 8 is a cross-sectional view of a base station antenna 70 according to a fourth embodiment of the present disclosure. The base station antenna 70 has a radome 73 and three reflecting plates 71, and each reflecting plate 71 has two longitudinal rim areas 72. In the fourth embodiment, the radome 73 and the radome supporting member 30 may be configured the same as in the first embodiment. The fourth embodiment can differ from the first embodiment mainly in that, as viewed in the cross section of the base station antenna 70, comparing with the reflecting plate 41, each reflecting plate 71 is farther away from the center of the circular base station antenna, wherein the longitudinal edge area of each reflecting plate 71 is bent in a radially inner part of a radome supporting structure formed by three radome supporting members 30.

It can be seen from the four embodiments of base station antennas shown in FIGS. 5 to 8 that the radome supporting member 30 according to the present disclosure can have a wide range of versatility; it can be applied to reflecting plates of different sizes and does not need to be specially designed for each type of reflecting plate.

In an embodiment not shown, the base station antenna may have two reflecting plates. When viewed in a cross-section, each reflecting plate may have a central body portion extending approximately in a ½ arc shape and two longitudinal rim areas. A corresponding radome supporting member may have a substantially 112 arc shape.

In other embodiment that are not shown, the base station antenna may have four, six, or other numbers of reflecting plates, which may substantially form an equilateral polygon in a cross section of the base station antenna.

It will be understood that, the terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprise” and “include” (and variants thereof), when used in this specification, specify the presence of stated operations, elements, and/or components, but do not preclude the presence or addition of one or more other operations, elements, components, and/or groups thereof. As used herein, the term “and/or” includes any and all combinations of one or more of the associated listed items. Like reference numbers signify like elements throughout the description of the figures.

The thicknesses of elements in the drawings may be exaggerated for the sake of clarity. Further, it will be understood that when an element is referred to as being “on,” “coupled to” or “connected to” another element, the element may be formed directly on, coupled to or connected to the other element, or there may be one or more intervening elements therebetween. In contrast, terms such as “directly on,” “directly coupled to” and “directly connected to,” when used herein, indicate that no intervening elements are present. Other words used to describe the relationship between elements should be interpreted in a like fashion (i.e., “between” versus “directly between”, “attached” versus “directly attached.” “adjacent” versus “directly adjacent”, etc.).

Terms such as “top,” “bottom,” “upper,” “lower,” “above,” “below,” and the like are used herein to describe the relationship of one element, layer or region to another element, layer or region as illustrated in the figures. It will be understood that these terms are intended to encompass different orientations of the device in addition to the orientation depicted in the figures.

It will be understood that, although the terms “first,” “second,” etc. may be used herein to describe various elements, these elements should not be limited by these terms. These terms are only used to distinguish one element from another. Thus, a first element could be termed a second element without departing from the teachings of the inventive concept.

It will also be appreciated that all example embodiments disclosed herein can be combined in any way.

Finally, it is to be noted that, the above-described embodiments are merely for understanding the present invention but not constitute a limit on the protection scope of the present invention. For those skilled in the art, modifications may be made on the basis of the above-described embodiments, and these modifications do not depart from the protection scope of the present invention.

1. A connecting element, comprising:
a body, which has a base surface, an end side extending laterally relative to the base surface, and a cavity open toward the end side, a slot opening toward the end side being provided in a wall of the cavity facing the base surface; and
a plug-in component, which protrudes from the base surface, is spaced apart from the end side, and has a stalk portion and a head portion;
wherein the connecting element is configured such that a matching pair of connecting elements can be connected to each other such that one connecting element is inserted into the cavity of the other connecting element with its head portion inserted from the end side of the other connecting element, wherein during insertion, the one connecting element is guided with its stalk portion in the slot of the other connecting element, and the base surfaces of the pair of connecting elements are opposing each other and are spaced apart from each other in a connected state.

2. The connecting element according to claim 1, wherein the connecting element has a spacer protruding laterally from the stalk portion of the plug-in component, the spacer divides the stalk portion into two sections, and the spacer is configured to space a first member received on a first side of the spacer facing the base surface apart from a second member received on a second side of the spacer facing away from the base surface.

3. The connecting element according to claim 2, wherein the stalk portion and the head portion are respectively formed as a plate-shaped component, and the connecting element has two spacers protruding laterally from two side surfaces of the stalk portion.

4. The connecting element according to claim 1, wherein the connecting element has a positioning component, which is configured to fix the connecting element in a movement direction of the connecting element defined by the base surface and the stalk portion.

5. The connecting element according to claim 4, wherein the positioning component is formed as a latch element or formed as a protrusion protruding from the base surface.

6. The connecting element according to claim 1, wherein the connecting element is formed integrally.

7. The connecting element according to claim 6, wherein the connecting element is integrally formed of a plastic material by injection molding.

8. The connecting element according to claim 1, wherein the connecting element is configured to be used for a base station antenna.

9. A connection device comprising a pair of the connecting elements according to claim 1, wherein the pair of connecting elements are connected to each other such that one connecting element is inserted into a cavity of the other connecting element with its head portion inserted from an end side of the other connecting element, wherein during insertion, the one connecting element is guided with its stalk portion in a slot of the other connecting element, and base surfaces of the pair of connecting elements are opposing each other and are spaced apart from each other in a connected state.

10. The connection device according to claim 9, wherein one of the connecting elements includes a spacer protruding laterally from the stalk portion of the plug-in component, the spacer dividing the stalk portion into two sections, and the spacer being configured to space a first member received on a first side of the spacer facing the base surface apart from a second member received on a second side of the spacer facing away from the base surface; and
wherein the other connecting element does not have a spacer.

11. The connection device according to claim 9, wherein one connecting element has a positioning component, formed as a latch element and the other connecting element has a positioning component formed as a protrusion protruding from its base surface.

12. A radome supporting member for a base station antenna, wherein the radome supporting member extends in an elongated shape and has at least one connecting element according to claim 1.

13. The radome supporting member for a base station antenna according to claim 12, wherein the radome supporting member is integrated with the connecting element respectively on two ends of the radome supporting member.

14. The radome supporting member for a base station antenna according to claim 12, wherein the radome supporting member has a connection part for installing accessories in its extension.

15. The radome supporting member for a base station antenna according to claim 12, wherein the radome supporting member and the connecting elements are integrally formed of a plastic material by injection molding.

16. The connection element of claim 1, in combination with a base station antenna.

17. The combination of claim 16, wherein the base station antenna includes a plurality of reflecting plates, the reflecting plates having longitudinal rim areas, wherein two of the longitudinal rim areas of at least two reflecting plates are adjacent to each other and spaced apart from each other, wherein the connecting element is mounted on the two longitudinal rim areas.
